(19) United States
(12) Patent Application Publication
(10) Pub. No.: US 2025/0034419 A1
(43) Pub. Date: Jan. 30, 2025

(54) INK SET AND METHOD OF INSPECTING A RECORDING HEAD

(71) Applicant: KYOCERA DOCUMENT SOLUTIONS INC., OSAKA (JP)

(72) Inventor: NORIAKI OZAWA, OSAKA (JP)

(21) Appl. No.: 18/780,508

(22) Filed: Jul. 23, 2024

(30) Foreign Application Priority Data
Jul. 25, 2023 (JP) 2023-120852

(51) Int. Cl. C09D 11/40; B41J 2/165; C09D 11/322

(52) U.S. Cl. CPC C09D 11/40; B41J 2/16579; C09D 11/322

(57) ABSTRACT

An ink set includes: an inkjet ink; and a recording head filling liquid. The inkjet ink includes a pigment, a first surfactant, and an aqueous medium. The recording head filling liquid includes a specific moisturizing agent, a second surfactant, and water. The specific moisturizing agent is a compound represented by the following general formula (1). The first surfactant and the second surfactant are each independently a compound represented by the following general formula (2).

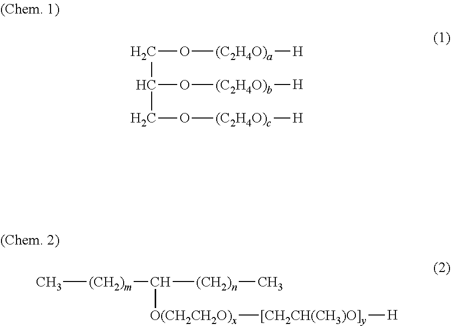

### CROSS-REFERENCE TO RELATED PATENT APPLICATION

This application claims the benefit of Japanese Priority Patent Application JP 2023-120852 filed Jul. 25, 2023, the entire contents of which are incorporated herein by reference.

### FIELD OF THE DISCLOSURE

The present disclosure relates to an ink set and a method of inspecting a recording head.

### BACKGROUND OF THE DISCLOSURE

Inkjet recording apparatuses include a recording head that ejects an inkjet ink. It is common practice to sufficiently inspect the ejection performance and the like of the recording head before shipment. In the inspection of the ejection performance of the recording head, the recording head is actually filled with an inkjet ink and an ejection test is performed.

However, if the recording head is shipped with the inkjet ink remaining in the ink flow path, the solvent in the inkjet ink evaporates during transportation and preservation, the solids of the inkjet ink (particularly, the pigment component) aggregate to generate aggregates. The above-mentioned aggregates can cause ejection failures in the recording head after shipment.

In this regard, manufactures of recording heads ship recording heads while filling the recording heads with a solution that does not contain a pigment component (hereinafter, referred to as a recording head filling liquid in some cases) in some cases. The recording head filling liquid is desired to be purgeable from the recording head even in the case where the recording head is left unused for a while.

Further, the recording head filling liquid enters the ink flow path of the recording head and dilutes the inkjet ink remaining in the ink flow path. For this reason, the recording head filling liquid is desired to be easily introduced into the ink flow path in the recording head.

As the recording head filling liquid, for example, a recording head filling liquid containing silicone oil has been proposed (Japanese Patent Application Laid-open No. 2010-227729).

### SUMMARY OF THE DISCLOSURE

However, the above-mentioned requirements cannot be met by Japanese Patent Application Laid-open No. 2010-227729.

In view of the circumstances as described above, it is desirable to provide an ink set that allows a recording head filling liquid to be easily introduced into an ink flow path in a recording head and is capable of effectively suppressing aggregation of a pigment component in an inkjet ink in the recording head and stably purging the recording head filling liquid. Further, it is also desirable to provide a method of inspecting a recording head using the above-mentioned ink set.

According to an embodiment of the present disclosure, there is provided an ink set, including: an inkjet ink; and a recording head filling liquid. The inkjet ink includes a pigment, a first surfactant, and an aqueous medium. The recording head filling liquid includes a specific moisturizing agent, a second surfactant, and water. The specific moisturizing agent is a compound represented by the following general formula (1). The first surfactant and the second surfactant are each independently a compound represented by the following general formula (2).

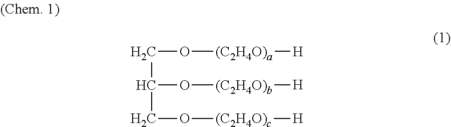

In the general formula (1), a, b, and c each independently represent an integer of 1 or more. a+b+c is 5 or more and 20 or less.

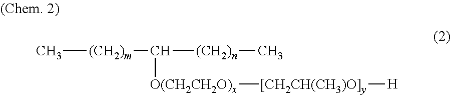

In the general formula (2), m and n each independently represent a number of 0.0 or more and 12.0 or less. m+n is 8.0 or more and 12.0 or less. x represents a number of 1.0 or more and 20.0 or less. y represents a number of 2.0 or more and 10.0 or less.

According to an embodiment of the present disclosure, there is provided a method of inspecting a recording head using the above-mentioned ink set, including: an inspection step of inspecting ejection performance of the recording head; and a filling step of filling the recording head after the inspection step with the recording head filling liquid. The ejection performance of the recording head is inspected by ejecting the inkjet ink by the recording head in the inspection step.

In accordance with the ink set according to an embodiment of the present disclosure, a recording head filling liquid can be easily introduced into an ink flow path in a recording head, and it is possible to effectively suppress aggregation of a pigment component in an inkjet ink in the recording head and stably purge the recording head filling liquid. In accordance with the method of inspecting a recording head according to an embodiment of the present disclosure, it is possible to suppress the occurrence of ejection failures in the recording head after inspection.

These and other objects, features and advantages of the present disclosure will become more apparent in light of the following detailed description of best mode embodiments thereof, as illustrated in the accompanying drawings.

### DETAILED DESCRIPTION OF THE EXEMPLARY EMBODIMENTS

Embodiments of the present disclosure will be described below. Note that in the following, unless otherwise specified, the measured value of the volume median diameter (D50) is a value measured using a dynamic light scattering particle size distribution analyzer (e.g., “Zetasizer (registered trademark) Nano ZS” manufactured by Malvern Panalytical Ltd.).

In the following, unless otherwise specified, the measured value of the acid value is a value measured in accordance with “Japanese Industrial Standard (JIS) K0070-1992”. Further, unless otherwise specified, the measured value of the mass average molecular weight (Mw) a value measured using gel permeation chromatography.

In the following, unless otherwise specified, the measured value of the dynamic surface tension is a value obtained by measuring the dynamic surface tension at the surface age of 10 ms and 25° C. by a maximum bubble pressure method using a bubble pressure dynamic surface tensiometer (e.g., “BP100” manufactured by KRUSS GmbH, capillary diameter of 0.4 mm).

In the following, unless otherwise specified, the measured value of viscosity is a value measured as 25° C. using a falling ball viscometer (e.g., “Lovis2000” manufactured by Anton Paar GmbH).

In the present specification, acrylic and methacrylic are collectively referred to as “(meth)acrylic” in some cases. Further, “at least one of A or B” means “A and/or B”.

### First Embodiment: Ink Set

An ink set according to a first embodiment of the present disclosure will be described below. The ink set according to this embodiment includes: an inkjet ink (hereinafter, referred to as an ink in some cases); and a recording head filling liquid (hereinafter, referred to as a filling liquid in some cases). The ink includes a pigment, a first surfactant, and an aqueous medium. The filling liquid includes a specific moisturizing agent, a second surfactant, and water. The specific moisturizing agent is a compound represented by the following general formula (1). The first surfactant and the second surfactant are each independently a compound represented by the following general formula (2).

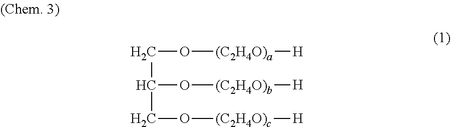

In the general formula (1), a, b, and c each independently represent an integer of 1 or more. a+b+c is 5 or more and 20 or less.

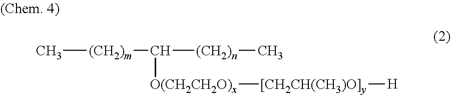

In the general formula (2), m and n each independently represent a number of 0.0 or more and 12.0 or less. m+n is 8.0 or more and 12.0 or less. x represents a number of 1.0 or more and 20.0 or less. y represents a number of 2.0 or more and 10.0 or less.

Note that in the ink set according to this embodiment, the filling liquid may include a plurality of types of compounds represented by the general formula (1). In this case, in the general formula (1), a, b, and c respectively represent number average values of a, b, and c in the plurality of types of compounds represented by the general formula (1).

Further, in the ink set according to this embodiment, the ink may include a plurality of types of compounds represented by the general formula (2). Further, the filling liquid may include a plurality of types of compounds represented by the general formula (2). In these cases, in the general formula (2), m, n, x, and y respectively represent number average values of m, n, x, and y in the plurality of types of compounds represented by the general formula (2).

In the ink set according to this embodiment, the recording head in which the ink remains is filled with the filling liquid to be used. For example, in the case where the ink is ejected by the recording head and then the recording head is left unused for a while for some reason, the recording head is filled with the filling liquid to be used. Specifically, the filling liquid is used by filling the recording head when the recording head is shipped, the recording head is preserved for a long time, or the recording head is transported. The ink set according to this embodiment is suitable as an ink set used for a method of inspecting a recording head according to a second embodiment.

By having the above-mentioned configuration, the ink set according to this embodiment allows the filling liquid to be easily introduced into the ink flow path in the recording head, and is capable of effectively suppressing aggregation of the pigment component (the pigment and the pigment coating resin) of the ink in the recording head and stably purging the filling liquid. The reasons for this are presumed to be as follows. The ink set according to this embodiment includes an ink and a filling liquid. The filling liquid enters the ink flow path of the recording head and dilutes the ink remaining in the ink flow path. This makes the ink remaining in the ink flow path difficult for the solids thereof to aggregate. In particular, in the ink set according to this embodiment, the filling liquid includes a specific moisturizing agent represented by the general formula (1). The specific moisturizing agent in which a, b, and c each represent an integer of 1 or more and a+b+c is 5 or more in the general formula (1) has low viscosity and does not increase the pressure (purge pressure) of the recording head when purging the filling liquid. For this reason, the ink set according to this embodiment is capable of stably purging the filling liquid from the recording head even after the recording head is left to stand. Further, although the reason is not clear, in accordance with the study by the present inventors, a moisturizing agent in which a+b+c exceeds 20 in the general formula (1) cannot sufficiently suppress aggregation of the pigment component in the ink in the recording head. By including the specific moisturizing agent in which a, b, and c each represent an integer of 1 or more and a+b+c is 5 or more and 20 or less in the general formula (1), the ink set according to this embodiment is capable of sufficiently suppressing aggregation of the pigment component in the ink in the recording head and stably purging the filling liquid.

Further, in the ink set according to this embodiment, the ink includes a compound represented by the general formula (2) as a first surfactant. Further, in the ink set according to this embodiment, the filling liquid includes a compound represented by the general formula (2) as a second surfactant. When the ink includes the compound represented by the general formula (2), the dynamic surface tension of the ink can be reduced. Further, when the filling liquid includes the compound represented by the general formula (2), the dynamic surface tension of the filling liquid can be reduced. The compound represented by the general formula (2) has a hydrophobic alkyl chain and a structure in which a propylene oxide group, which is more hydrophobic than an ethylene oxide group, is bonded to an ethylene oxide group ether-bonded to the alkyl chain. For this reason, the compound represented by the general formula (2) is highly hydrophobic and has good wettability. For these reasons, in the ink set according to this embodiment, when mixing the ink and the filling liquid, the filling liquid is easily introduced into the ink flow path in the recording head. The ink set according to this embodiment will be described below in more detail. Note that the components described below may be used alone or two or more of them may be used in combination.

### [Ink]

The ink includes a pigment, a first surfactant, and an aqueous medium. In the ink, the pigment forms pigment particles together with, for example, a pigment coating resin. For this reason, the ink favorably includes a pigment, a pigment coating resin, a first surfactant, and an aqueous medium. The pigment particles are present to be dispersed in a solvent. From the viewpoint of optimizing the color density, hue, or stability of the ink, D₅₀ of the pigment particles is favorably 30 nm or more and 300 nm or less, more favorably 50 nm or more and 150 nm or less.

### (Pigment)

Examples of the pigment included in the ink include a yellow pigment, an orange pigment, a red pigment, a blue pigment, a purple pigment, and a black pigment. Examples of the yellow pigment include C.I. Pigment Yellow (74, 93, 95, 109, 110, 120, 128, 138, 139, 151, 154, 155, 173, 180, 185, and 193). Examples of the orange pigment include C.I. Pigment Orange (34, 36, 43, 61, 63, and 71). Examples of the red pigment include C.I. Pigment Red (122 and 202). Examples of the blue pigment include C.I. Pigment Blue (15, more specifically 15:3). Examples of the purple pigment include C.I. Pigment Violet (19, 23, and 33). Examples of the black pigment include C.I. Pigment Black (7).

In the ink, the content ratio of the pigment is favorably 2.0 mass % or more and 15.0 mass % or less, more favorably 5.0 mass % or more and 10.0 mass % or less. When the content ratio of the pigment is 2.0 mass % or more, it is easier to form images with desired image density. Further, when the content ratio of the pigment is 15.0 mass % or less, the fluidity of the ink can be ensured.

### (Pigment Coating Resin)

The pigment coating resin is a resin soluble in the ink. Part of the pigment coating resin is present on, for example, the surface of pigment particles, and imparts dispersibility to the pigment particles. Part of the pigment coating resin is present in, for example, a state of being dissolved in the ink.

Examples of the pigment coating resin include a copolymer of at least one monomer of (meth)acrylic acid alkylester, styrene, and vinylnaphthalene and at least one monomer of (meth)acrylic acid and maleic acid.

As the pigment coating resin, a styrene-(meth)acrylic resin is favorable. The styrene-(meth)acrylic resin includes a repeating unit derived from at least one monomer of (meth)acrylic acid alkylester and (meth)acrylic acid and a styrene unit. Examples of the (meth)acrylic acid alkylester include methyl (meth)acrylate, ethyl (meth)acrylate, propyl (meth)acrylate, and butyl (meth)acrylate. As the styrene-(meth)acrylic resin, a copolymer (X) of styrene, methyl methacrylate, methacrylic acid, butyl acrylate is favorable. The copolymer (X) is favorably neutralized by an equal amount of a basic compound (e.g., potassium hydroxide or sodium hydroxide).

In all repeating units included in the copolymer (X), the content ratio of the repeating unit derived from styrene is favorably 10.0 mass % or more and 20.0 mass % or less. In all repeating units included in the copolymer (X), the content ratio of the repeating unit derived from methyl methacrylate is favorably 10.0 mass % or more and 20.0 mass % or less. In all repeating units included in the copolymer (X), the content ratio of the repeating unit derived from methacrylic acid is favorably 35.0 mass % or more and 45.0 mass % or less. In all repeating units included in the copolymer (X), the content ratio of the repeating unit derived from butyl acrylate is favorably 25.0 mass % or more and 35.0 mass % or less.

In the ink, the content ratio of the pigment coating resin is favorably 0.7 mass % or more and 6.0 mass % or less, more favorably 2.0 mass % or more and 4.0 mass % or less. When the content ratio of the pigment coating resin is 0.7 mass % or more and 6.0 mass % or less, it is possible to prevent the nozzle from being clogged by the ink.

The acid value of the pigment coating resin is favorably 30 mgKOH/g or more and 300 mgKOH/g or less, more favorably 50 mgKOH/g or more and 150 KOH/g or less. When the acid value of the pigment coating resin is 30 mgKOH/g or more and 300 mgKOH/g or less, the preservation stability of the ink can be optimized while optimizing the dispersibility of the pigment.

The acid value of the pigment coating resin can be adjusted by changing the amount of the monomer to be used when synthesizing the pigment coating resin. For example, by using a monomer (more specifically, acrylic acid, methacrylic acid, or the like) having an acidic functional group (e.g., a carboxy group) when synthesizing the pigment coating resin, it is possible to increase the acid value of the pigment coating resin.

The Mw of the pigment coating resin is favorably 10000 or more and 50000 or less, more favorably 15000 or more and 25000 or less. When the Mw of the pigment coating resin is 10000 or more and 50000 or less, it is possible to optimize the image density of an image to be formed by the ink while suppressing an increase in the viscosity of the ink.

The Mw of the pigment coating resin can be adjusted by changing the polymerization conditions of the pigment coating resin (more specifically, the amount of a polymerization initiator used, the polymerization temperature, the polymerization time, and the like).

In the polymerization of the pigment coating resin, the amount of polymerization initiator used is favorably 0.001 moles or more and 5.0 moles or less, more favorably 0.01 moles or more and 2.0 moles or less, to 1 mole of the monomer mixture. In the polymerization of the pigment coating resin, for example, the polymerization temperature can be 50° C. or more and 70° C. or less, and the polymerization time can be 10 hours or more and 24 hours or less. Note that it is favorable to neutralize the polymerized pigment coating resin by an equal amount of a basic compound and then use the neutralized polymerized pigment coating resin as a raw material of the ink. As the basic compound, a hydroxide of alkali metal ions (e.g., potassium hydroxide or sodium hydroxide).

### (First Surfactant)

The first surfactant is the above-mentioned compound represented by the general formula (2). In the general formula (2), m and n each independently represent a number of 0.0 or more and 12.0 or less. m+n is 8.0 or more and 12.0 or less. In the general formula (2), it is favorable that m and n each independently represent a number of 0.0 or more and 11.0 or less and m+n represent is 9.0 or more and 11.0 or less. Further, in the general formula (2), x represents a number of 1.0 or more and 20.0 or less. y represents a number of 2.0 or more and 10.0 or less. x favorably represents a number of 6.0 or more and 16.0 or less, more favorably a number of 6.0 or more and 8.0 or less. y favorably represents a number of 2.0 or more and 3.0 or less. Further, in the general formula (2), it is still more favorable that x represents a number of 6.0 or more and 8.0 or less and y represents a number of 2.0 or more and 3.0 or less.

The compound represented by the general formula (2) is a nonionic surfactant having a polyoxyalkylenealkylether as the main skeleton and has an ether bond (—O—) that does not dissociate into ions even when dissolved in water in the molecule. Further, the compound represented by the general formula (2) has a hydrophobic alkyl chain where m+n in the general formula (2) is 8.0 or more and 12.0 or less. Further, the compound represented by the general formula (2) has a structure in which a propylene oxide group (—[CH₂CH(CH₃)O]—), which is more hydrophobic than an ethylene oxide group, is bonded to an ethylene oxide group (—[CH₂CH₂O]—) ether-bonded to the above-mentioned alkyl chain. For this reason, the compound represented by the general formula (2) is highly hydrophobic and has good wettability.

Examples of commercial products of the compound represented by the general formula (2) include “SOFTANOL (registered trademark) EP5035”, “SOFTANOL (registered trademark) EP7025”, “SOFTANOL (registered trademark) EP7045”, “SOFTANOL (registered trademark) EP7085”, “SOFTANOL (registered trademark) EP9050”, and “SOFTANOL (registered trademark) EP12030” manufactured by NIPPON SHOKUBAI CO., LTD.

In the ink, the content ratio of the first surfactant (in other words, the compound represented by the general formula (2)) is favorably 0.1 mass % or more and 2.5 mass % or less, more favorably 0.1 mass % or more and 1.0 mass % or less, and still more favorably 0.1 mass % or more and 0.5 mass % or less. When the content ratio of the first surfactant is 0.1 mass % or more and 2.5 mass % or less, it is possible to more reliably introduce the filling liquid into the ink flow path in the recording head. For this reason, it is possible to reliably obtain an ink set that allows a filling liquid to be easily introduced into an ink flow path in a recording head and is capable of effectively suppressing aggregation of a pigment component in an ink in the recording head and stably purging the filling liquid.

### (Other Surfactants)

The ink may include only the first surfactant as a surfactant, but may further include another surfactant (hereinafter, referred to as a different surfactant) other than the first surfactant. Regarding the surfactants, the content ratio of the first surfactant is favorably 60.0 mass % or more, more favorably 80.0 mass % or more.

Examples of the different surfactant include a surfactant in which y represents a number of 1.0 or less in the general formula (2), an acetylene glycol surfactant (surfactant including an acetylene glycol compound), a silicone surfactant (surfactant including a silicone compound), and a fluorosurfactant (surfactant including a fluoropolymer or a fluorine-containing compound). Examples of the acetylene glycol surfactant include an ethylene oxide adduct of acetylene glycol and a propylene oxide adduct of acetylene glycol.

In the ink, the content ratio of the different surfactant is favorably 0.1 mass % or more and 0.5 mass % or less, more favorably 0.1 mass % or more and 0.3 mass % or less.

### (Aqueous Medium)

The aqueous medium included in the ink is a medium including water. The aqueous medium may function as a solvent or a dispersion medium. Specific examples of the aqueous medium include an aqueous medium including water and a water-soluble organic solvent.

In the ink, the content ratio of the aqueous medium is favorably 30.0 mass % or more and 95.0 mass % or less, more favorably 70.0 mass % or more and 95.0 mass % or less.

### (Water)

Water is a main solvent of the ink. In the ink, the content ratio of water is favorably, for example, 20.0 mass % or more and 80.0 mass % or less, more favorably 50.0 mass % or more and 70.0 mass % or less.

### (Water-Soluble Organic Solvent)

The ink favorably further includes a water-soluble organic solvent. Examples of the water-soluble organic solvent in the ink include a glycol compound, a glycolether compound, a lactam compound, a nitrogen-containing compound, an acetate compound, thiodiglycol, glycerin, and dimethylsulfoxide.

Examples of the glycol compound include ethylene glycol, 1,3-propanediol, propylene glycol, 1,5-pentanediol, 1,2-octanediol, 1,8-octanediol, 3-methyl-1,5-pentanediol, diethylene glycol, triethylene glycol, and tetraethylene glycol.

Examples of the glycolether compound include diethylene glycol diethylether, diethylene glycol monobutylether, ethylene glycol monomethylether, ethylene glycol monobutylether, diethylene glycol monomethylether, diethylene glycol monoethylether, diethylene glycol diethylether, triethylene glycol monomethylether, triethylene glycol monoethylether, triethylene glycol monobutylether, and propylene glycol monomethylether.

Examples of the lactam compound include 2-pyrrolidone and N-methyl-2-pyrrolidone.

Examples of the nitrogen-containing compound include 1,3-dimethylimidazolidinone, formamide, and dimethylformamide.

Examples of the acetate compound include diethylene glycol monoethylether acetate.

As the water-soluble organic solvent in the ink, triethylene glycol monobutylether, 2-pyrrolidone, or glycerin is favorable.

The content ratio of the water-soluble organic solvent in the ink is favorably 10.0 mass % or more and 80.0 mass % or less, more favorably 20.0 mass % or more and 40.0 mass % or less. When the content ratio of the water-soluble organic solvent is 10.0 mass % or more and 80.0 mass % or less, it is possible to more stably eject the ink from the recording head.

### (Additive)

The ink may further include, as necessary, known additives (e.g., a dissolution stabilizer, an anti-drying agent, an antioxidant, a viscosity adjustor, a pH adjuster, and an antifungal agent).

### (Favorable Composition)

The ink favorably has, for example, one of compositions 1 to 6 shown in the following Table 1. Note that in the following Table 1, the “ratio” represents a numerical range of a favorable content ratio [mass %]. For example, “5.4-6.6” in Table 1, which is the ratio of the pigment in the composition 1, represents including 5.4 mass % or more and 6.6 mass % or less of the pigment. The same applies also to the notations of the other columns. “S-1”, “S-3”, “S-4”, and “S-5” in the type of the first surfactant respectively represent surfactants (S-1), (S-3), (S-4), and (S-5) used in Examples. The “resin” represents a pigment coating resin. “TGBE” represents triethylene glycol mono-n-butylether.

TABLE 1

| Composition | | 1 | 2 | 3 | 4 | 5 | 6 |
|---|---|---|---|---|---|---|---|
| Ratio of pigment | | 5.4-6.6 | 5.4-6.6 | 5.4-6.6 | 5.4-6.6 | 5.4-6.6 | 5.4-6.6 |
| Ratio of resin | | 2.2-2.6 | 2.2-2.6 | 2.2-2.6 | 2.2-2.6 | 2.2-2.6 | 2.2-2.6 |
| First | Type | S-1 | S-3 | S-4 | S-5 | S-1 | S-1 |
| surfactant | Ratio | 0.2-0.4 | 0.2-0.4 | 0.2-0.4 | 0.2-0.4 | 0.1-0.3 | 0.8-1.0 |

| Ratio of different | | 0.1-0.3 | 0.1-0.3 | 0.1-0.3 | 0.1-0.3 | 0.1-0.3 | 0.1-0.3 |
|---|---|---|---|---|---|---|---|
| surfactant | | | | | | | |
| Ratio of | TGBE | 3.6-4.4 | 3.6-4.4 | 3.6-4.4 | 3.6-4.4 | 3.6-4.4 | 3.6-4.4 |
| aqueous | 2-pyrrolidone | 4.5-5.5 | 4.5-5.5 | 4.5-5.5 | 4.5-5.5 | 4.5-5.5 | 4.5-5.5 |
| medium | Glycerin | 18.0-22.0 | 18.0-22.0 | 18.0-22.0 | 18.0-22.0 | 18.0-22.0 | 18.0-22.0 |
| | Water | Remainder | Remainder | Remainder | Remainder | Remainder | Remainder |

### (Method of Producing Ink)

The ink can be produced by, for example, mixing a pigment dispersion liquid including a pigment, a first surfactant, an aqueous medium, and a component added as necessary (e.g., a different surfactant or additive). The first surfactant can be produced by, for example, mixing branched alcohol and KOH, dehydrating the obtained mixed solution for 15 minutes to 45 minutes while causing the mixture to react at 90° C. to 130° C. and 1.1 kPa to 1.5 kPa, adding ethyleneoxide, and then causing the obtained mixture to react at 135 to 175° C. for 15 minutes to 45 minutes. By checking that no components of each raw material remain by gas chromatography analysis of the reaction solution, it can be made sure that a target substance represented by the general formula (2) is obtained. The pigment dispersion liquid includes a pigment, a pigment coating resin, and water. The pigment coating resin is prepared by, for example, neutralizing an alkali-soluble resin by an equal amount of a basic compound (e.g., sodium hydroxide). The pigment dispersion liquid can be prepared by adding a pigment to an aqueous solution including the pigment coating resin and dispersing the obtained mixture. Examples of the apparatus used for dispersion include a bead mill. In the production of the ink, after the dispersion, foreign substances and coarse particles may be removed by a filter (e.g., a filter having a pore size of 5 μm or less).

### [Filling Liquid]

The filling liquid include a specific moisturizing agent, a second surfactant, and water.

### (Specific Moisturizing Agent)

The specific moisturizing agent is a compound represented by the above-mentioned general formula (1). In the general formula (1), a, b, and c each independently represent an integer of 1 or more. a+b+c is 5 or more and 20 or less. a+b+c favorably represent an integer of 6 or more and 18 or less, more favorably 6 or more and 15 or less, and still more favorably 6 or more and 9 or less. When a+b+c is small, the pressure (purge pressure) of the recording head when purging the filling liquid increases. Meanwhile, when a+b+c is large, aggregation of the pigment component in the ink cannot be sufficiently suppressed. The specific moisturizing agent in which a+b+c is an integer of 5 or more and 20 or less in the general formula (1) has low viscosity (e.g., viscosity at 25° C. is 450 mPa·s or less) and does not increase the pressure (purge pressure) of the recording head when purging the filling liquid. Further, the specific moisturizing agent in which a+b+c is an integer of 5 or more and 20 or less in the general formula (1) is capable of maintaining high dispersion stability of the pigment component in the ink and effectively suppressing aggregation of the pigment component in the ink in the recording head. Further, when a+b+c is, for example, 6 or more and 18 or less in the general formula (1), it is possible to more effectively suppress aggregation of the pigment component in the ink in the recording head.

In the general formula (1), a, b, and c may be the same or different from each other. In the general formula (1), a, b, and c can be changed in various ways by, for example, adjusting reaction conditions such as the reaction temperature and reaction time between glycerin and polyethylene glycol. Therefore, in the general formula (1), a, b, and c may satisfy the following relationship: a=b=c, a=c≠b, or a≠b≠c. Further, only one of a or c may be the same as b.

Although a, b, and c can each be independently set in the general formula (1) as described above, it is favorable that a, b, and c satisfy the following relationship: a=b=c or a=c≠b in the general formula (1). By using these specific moisturizing agents, it is possible to more effectively suppress aggregation of the pigment component in the ink in the recording head and more stably purge the filling liquid. Note that in the case where a, b, and c satisfy the following relationship: a=b=c in the general formula (1), a+b+c can be freely set within the range of a multiple of 3, of 6 or more and 18 or less.

Further, in the case where a, b, and c satisfy the following relationship: a=c≠b in the general formula (1), a and c, and b can be freely set within the range in which a+b+c is 5 or more and 20 or less (however, as described above, a, b, and c each independently represent an integer of 1 or more). However, in the case where a, b, and c satisfy the following relationship: a=c≠b in the general formula (1), b is favorably a+1 or a+2. In this case, it is possible to more effectively suppress aggregation of the pigment component in the ink in the recording head and more stably purge the filling liquid.

The viscosity of the specific moisturizing agent at 25° C. is favorably 230 mPa·s or more and 450 mPa·s or less, more favorably 270 mPa·s or more and 450 mPa·s or less, still more favorably 300 mPa·s or more and 450 mPa·s or less, and still more favorably 340 mPa·s or more and 410 mPa·s or less. When the viscosity of the specific moisturizing agent is 230 mPa·s or more and 450 mPa·s or less, it is possible to effectively suppress aggregation of the pigment component in the ink in the recording head. Further, it is possible to stably purge the filling liquid from the recording head even after the recording head is left to stand.

The content ratio of the specific moisturizing agent in the filling liquid is favorably 10.0 mass % or more and 50.0 mass % or less, more favorably 25.0 mass % or more and 40.0 mass % or less. When the content ratio of the specific moisturizing agent in the filling liquid is 10.0 mass % or more and 50.0 mass % or less, it is possible to effectively suppress aggregation of the pigment component in the ink in the recording head. Further, it is possible to stably purge the filling liquid from the recording head even after the recording head is left to stand. Further, when the content ratio of the specific moisturizing agent in the filling liquid is 25.0 mass % or more and 40.0 mass % or less, it is possible to more effectively suppress aggregation of the pigment component in the ink in the recording head.

### (Second Surfactant)

Similarly to the first surfactant, the second surfactant is also the compound represented by the above-mentioned general formula (2). The compound represented by the general formula (2) used as the second surfactant can be, for example, the same as the compound represented by the general formula (2) used as the first surfactant. For this reason, redundant description is omitted. The first surfactant and the second surfactant may be the same compound or different compounds but are favorably the same compound.

In the filling liquid, the content ratio of the second surfactant (in other words, the compound represented by the general formula (2)) is favorably 0.1 mass % or more and 2.5 mass % or less, more favorably 0.1 mass % or more and 1.0 mass % or less, and still more favorably 0.1 mass % or more and 0.5 mass % or less. When the content ratio of the second surfactant is 0.1 mass % or more and 2.5 mass % or less, it is possible to more reliably introduce the filling liquid into the ink flow path in the recording head when mixing the ink and the filling liquid. For this reason, it is possible to reliably obtain an ink set that allows a filling liquid to be easily introduced into an ink flow path in a recording head and is capable of effectively suppressing aggregation of a pigment component in an ink in the recording head and stably purging the filling liquid.

### (Water)

Water is a main solvent of the filling liquid. In the filling liquid, the content ratio of water is favorably, for example, 35.0 mass % or more and 95.0 mass % or less, more favorably 45.0 mass % or more and 85.0 mass % or less.

### (Other Components)

The filling liquid may further include, as necessary, known additives (e.g., a dissolution stabilizer, an anti-drying agent, an antioxidant, a viscosity adjustor, a pH adjuster, and an antifungal agent).

### (Favorable Composition)

The filling liquid favorably has one of compositions 1 to 18 shown in the following Table 2. Note that in the following Table 2, the “ratio” represents a numerical range of a favorable content ratio [mass %]. For example, “27.0-33.0”, which is the ratio of the specific moisturizing agent in the composition 1, represents including 27.0 mass % or more and 33.0 mass % or less of the specific moisturizing agent. The same applies also to the notations of the other columns. “M-2”, “M-3”, “M-4”, “M-5”, “M-8”, “M-9”, “M-10”, and “M-11 in the type of the specific moisturizing agent respectively represent moisturizing agents (M-2), (M-3), (M-4), (M-5), (M-8), (M-9), (M-10), and (M-11) used in Examples. “S-1”, “S-3”, “S-4”, and “S-5” in the type of the second surfactant respectively represent surfactants (S-1), (S-3), (S-4), and (S-5) used in Examples.

TABLE 2

| | Specific | | Second | | |
|---|---|---|---|---|---|
| Com- | moisturizing agent | | surfactant | | Water |
| position | Type | Ratio | Type | Ratio | Ratio |
| 1 | M-2 | 27.0-33.0 | S-1 | 0.1-0.3 | Remaining amount |
| 2 | M-3 | 27.0-33.0 | S-1 | 0.1-0.3 | Remaining amount |
| 3 | M-4 | 27.0-33.0 | S-1 | 0.1-0.3 | Remaining amount |
| 4 | M-5 | 27.0-33.0 | S-1 | 0.1-0.3 | Remaining amount |
| 5 | M-8 | 27.0-33.0 | S-1 | 0.1-0.3 | Remaining amount |
| 6 | M-9 | 27.0-33.0 | S-1 | 0.1-0.3 | Remaining amount |
| 7 | M-10 | 27.0-33.0 | S-1 | 0.1-0.3 | Remaining amount |
| 8 | M-11 | 27.0-33.0 | S-1 | 0.1-0.3 | Remaining amount |
| 9 | M-2 | 13.0-17.0 | S-1 | 0.1-0.3 | Remaining amount |
| 10 | M-2 | 41.0-49.0 | S-1 | 0.1-0.3 | Remaining amount |
| 11 | M-3 | 32.0-38.0 | S-1 | 0.1-0.3 | Remaining amount |
| 12 | M-3 | 32.0-38.0 | S-3 | 0.1-0.3 | Remaining amount |
| 13 | M-2 | 32.0-38.0 | S-4 | 0.1-0.3 | Remaining amount |
| 14 | M-2 | 32.0-38.0 | S-5 | 0.1-0.3 | Remaining amount |
| 15 | M-2 | 32.0-38.0 | S-1 | 0.1-0.3 | Remaining amount |
| 16 | M-2 | 27.0-33.0 | S-1 | 0.1-0.3 | Remaining amount |
| 17 | M-2 | 27.0-33.0 | S-1 | 0.1-0.3 | Remaining amount |
| 18 | M-2 | 32.0-38.0 | S-1 | 0.8-1.0 | Remaining amount |

The combination of the specific moisturizing agent and the second surfactant is not particularly limited, and they can be combined in various ways within the range described above. However, as the combination of the specific moisturizing agent and the second surfactant, for example, the combination that the specific moisturizing agent is the moisturizing agent (M-2), (M-3), or (M-8) and the second surfactant is the surfactant (S-1) is favorable. Therefore, in the ink set according to this embodiment, it is favorable that the specific moisturizing agent is a compound in which a+b+c is 6 or more and 10 or less in the general formula (1) and the second surfactant is a compound in which x represents a number of 6.0 or more and 8.0 or less and y represents a number of 2.0 or more and 3.0 or less in the general formula (2). Further, as described above, it is favorable that the first surfactant and the second surfactant are the same compound. Therefore, in the ink set according to this embodiment, it is favorable that the specific moisturizing agent is a compound in which a+b+c is 6 or more and 10 or less in the general formula (1) and the first surfactant and the second surfactant are each a compound in which x represents a number of 6.0 or more and 8.0 or less and y represents a number of 2.0 or more and 3.0 or less in the general formula (2).

### (Method of Producing Filling Liquid)

The filling liquid can be produced by, for example, mixing a specific moisturizing agent, a second surfactant, water, and a component added as necessary (e.g., additive). The specific moisturizing agent in which a, b, and c satisfy the following relationship: a=b=c in the general formula (1) can be produced by causing polyethylene glycol and glycerin to react with each other at, for example, 180 to 220° C. to form an ether. The specific moisturizing agent in which a, b, and c satisfy the following relationship: a=c≠b in the general formula (1) can also be produced by causing polyethylene glycol and glycerin to react with each other to form an ether. However, in the production of the specific moisturizing agent in which a, b, and c satisfy the following relationship: a=c≠b in the general formula (1), first, polyethylene glycol and glycerin are caused to react with each other at, for example, 140 to 180° C. to complete the reaction of the two hydroxy groups at the α-positions bonded to the primary carbons of glycerin. This forms an intermediate. Subsequently, this intermediate and polyethylene glycol are caused to react with each other at, for example, 200 to 240° C. to complete the reaction of the hydroxy group at the β-position bonded to the secondary carbon of glycerin. In this way, the specific moisturizing agent in which a, b, and c satisfy the following relationship: a=c≠b in the general formula (1) can be produced. The method of producing the second surfactant can be the same as, for example, that for the first surfactant.

### [Dynamic Surface Tension]

As described above, the ink set according to this embodiment allows the dynamic surface tension of the ink to be reduced when the ink includes the compound represented by the general formula (2) as the first surfactant. Further, the ink set according to this embodiment allows the dynamic surface tension of the filling liquid to be reduced when the filling liquid includes the compound represented by the general formula (2) as a second surfactant. Each of the dynamic surface tension of the ink and the dynamic surface tension of the filling liquid at the surface age of 10 ms and 25° C. is favorably 35.0 mN/m or less. When each of the dynamic surface tension of the ink and the dynamic surface tension of the filling liquid at the surface age of 10 ms and 25° C. is 35.0 mN/m or less, the ink and the filling liquid wet and spread in the recording head in a short time. As a result, when mixing the ink and the filling liquid, the filling liquid can be easily introduced into the ink flow path in the recording head. Further, when each of the dynamic surface tension of the ink and the dynamic surface tension of the filling liquid at the surface age of 10 ms and 25° C. is 25.0 mN/m or more and 5.0 mN/m or less, it is possible to more reliably introduce the filling liquid into the ink flow path in the recording head when mixing the ink and the filling liquid.

### Second Embodiment: Method of Inspecting Recording Head

A method of inspecting a recording head according to a second embodiment of the present disclosure will be described below. The method of inspecting a recording head according to an embodiment of the present disclosure is a method of inspecting a recording head using the ink set according to the first embodiment, including: an inspection step of inspecting ejection performance of the recording head; and a filling step of filling the recording head after the inspection step with the filling liquid. In the inspection step, the ejection performance of the recording head is inspected by ejecting the ink by the recording head. The ink set to be used in the method of inspecting a recording head according to this embodiment can be the same as the ink set described in the first embodiment. For this reason, redundant description is omitted.

Since the method of inspecting a recording head according to this embodiment uses the ink set according to the first embodiment, it is possible to suppress the occurrence of ejection failures in the recording head after inspection. The method of inspecting a recording head according to this embodiment is performed, for example, before the manufacturer of the recording head ships the recording head. Although the recording head to be inspected by the method of inspecting a recording head according to this embodiment is not particularly limited, examples thereof include a piezo recording head and a thermal recording head. The recording head may be, for example, a line-type recording head.

### [Inspection Step]

In this step, the ejection performance of the recording head is inspected. Specifically, in this step, the ejection performance of the recording head is inspected by ejecting the ink by the recording head. The ink remains in the ink flow path in the recording head inspected in this step.

In this step, the recording head after the inspection step may be cleaned. Although the method of cleaning the recording head is not particularly limited, examples thereof include a method of filling the recording head with a cleaning solution and then ejecting the cleaning solution from the recording head. Examples of the cleaning solution include a cleaning solution including water or a water-soluble organic solvent. In this step, even when the recording head is cleaned, it is difficult to completely remove the ink in the ink flow path.

### [Filling Step]

In this step, the recording head is filled with the filling liquid. After this step, the recording head is, for example, preserved in preparation for shipment or transported for shipment. After the recording head is delivered to a user, the filling liquid can be drained from the recording head by ejecting the filling liquid from the recording head.

### EXAMPLES

Examples of the present disclosure will be described below. However, the present disclosure is not limited to the following Examples.

In Examples, the Mw of each of the alkali-soluble resin and the surfactant was measured under the following conditions using gel permeation chromatography (“HLC-8020GPC” manufactured by TOSOH CORPORATION). The calibration curves were created using F-40, F-20, F-4, F-1, A-5000, A-2500, and A-1000, which are TSKgel standard polystyrene manufactured by TOSOH CORPORATION, and n-propylbenzene.

### (Measurement Conditions for Mass Average Molecular Weight)

Column: “TSKgel SuperMultiporeHZ-H” (semi-microcolumn of 4.6 mm I.D.×15 cm) manufactured by TOSOH CORPORATION
Number of columns: 3
Eluent: tetrahydrofuran
Flow rate: 0.35 mL/min
Sample injection amount: 10 μL
Measurement temperature: 40° C.
Detector: IR detector

### [Study 1: Type and Amount of Moisturizing Agent in Filling Liquid]

First, the type and amount of the moisturizing agent used in the filling liquid were studied. The method of preparing each raw material used for manufacturing the ink will be described below.

### [Preparation of Pigment Dispersion Liquid]

A pigment dispersion liquid (D-1) to be used for preparing the ink was prepared. In the preparation of the pigment dispersion liquid (D-1), first, a pigment coating resin solution including a pigment coating resin (R-1) and water was prepared.

### (Preparation of Pigment Coating Resin Solution)

An alkali-soluble resin that includes a repeating unit derived from methacrylic acid (MAA unit), a repeating unit derived from methyl methacrylate (MMA unit), a repeating unit derived from butyl acrylate (BA unit), and a repeating unit derived from styrene (ST unit) was prepared. The mass average molecular weight (Mw) of this alkali-soluble resin was 20000, and the acid value thereof was 100 mgKOH/g. The mass ratio of each repeating unit in this alkali-soluble resin satisfies the following relationship: “MAA unit:MMA unit:BA unit:ST unit=40:15:30:15”. This alkali-soluble resin and an aqueous sodium hydroxide solution were mixed (neutralization treatment). The neutralization treatment neutralized the alkali-soluble resin with sodium hydroxide (NaOH). In the neutralization treatment, the amount of the aqueous sodium hydroxide solution used was 1.05 times the theoretical value of the amount of the aqueous sodium hydroxide solution necessary for neutralizing the alkali-soluble resin. In this way, the alkali-soluble resin was neutralized with an equal amount (strictly speaking, 105%) of sodium hydroxide. In this way, a pigment coating resin solution including the pigment coating resin (R-1) (neutralized alkali-soluble resin) and water was obtained.

### (Dispersion)

A magenta pigment (C.I. Pigment Red 122), the above-mentioned pigment coating resin solution including the pigment coating resin (R-1), a surfactant A, and ion exchanged water were added to a vessel of a media-type wet disperser (“DYNO (registered trademark)-MILL” manufactured by Willy A Bachofen AG (WAB)) such that the composition shown in the following Table 3 is obtained.

Note that the content ratio of “water” in the following Table 3 represents the total content ratio of the above-mentioned ion exchanged water added to a vessel, and water contained in the pigment coating resin solution (in detail, water contained in the aqueous sodium hydroxide solution used for neutralizing the alkali-soluble resin and water generated by the neutralization reaction between the alkali-soluble resin and sodium hydroxide). Further, the surfactant A represents “OLFINE (registered trademark) E1010” (ethylene oxide adduct of acetylene glycol) manufactured by Nissin Chemical co., ltd., which is an acetylene glycol surfactant (nonionic surfactant).

TABLE 3

| Pigment dispersion liquid (D-1) | Content ratio [mass %] |
|---|---|
| Magenta pigment | 15.0 |
| Pigment coating resin | 6.0 |
| (R-1)(Neutralized with NaOH) | |
| Surfactant A | 0.5 |
| Water | 78.5 |
| Total | 100.0 |

Subsequently, the content of the vessel was wet-dispersed. As media, zirconia beads (particle diameter of 1.0 mm) were used. The amount of added media was set to 70 volume % to the volume of the vessel. The dispersion conditions were a temperature of 10° C. and a circumferential speed of 8 m/sec. In this way, a pigment dispersion liquid was obtained.

The volume median diameter (D50) of pigment particles included in the obtained pigment dispersion liquid (D-1) was measured. In detail, the obtained pigment dispersion liquid (D-1) was 300-fold diluted with ion exchanged water and used as a measurement sample. D₅₀ of the pigment particles in the measurement sample was measured using a dynamic light scattering particle size distribution analyzer (“Zetasizer (registered trademark) Nano ZS” manufactured by Malvern Panalytical Ltd.). D₅₀ of the pigment particles in the measurement sample was used as D₅₀ of the pigment particles included in the pigment dispersion liquid (D-1). Note that the measurement was performed 10 times and the average value of the measurement results was used as D₅₀ of the pigment particles. D₅₀ of the pigment particles included in the pigment dispersion liquid (D-1) was 100 nm.

### [Preparation of Ink]

### [Preparation of (I-1)]

Ion exchanged water was added to a flask equipped with a stirrer (“Three-One Motor (registered trademark) BL-600” manufactured by Shinto Scientific Co., Ltd.). While stirring the content with the above-mentioned stirrer (stirring speed: 400 rpm), the pigment dispersion liquid (D-1) (6.0 parts by mass of a pigment and 2.4 parts by mass of the pigment coating resin (R-1)), the surfactant (S-1) shown in the following Table 4, triethylene glycol mono-n-butylether, 2-pyrrolidone, and glycerin were added in this order. Details of the surfactant (S-1) used for preparing the ink (I-1) are shown in the following Table 4. Note that in the following Table 4, m+n, x, and y respectively represent numerical values of m+n, x, and y of the surfactant in the general formula (2). Further, in the following Table 4, “(R)” represents registered trademark. The ratio of the amount of each raw material added was as shown in the following Table 5.

TABLE 4

| Surfactant | m + n | X | Y | Manufacturer | Product name |
|---|---|---|---|---|---|
| S-1 | 10.0 | 7.0 | 2.5 | NIPPON | SOFTANOL(R)EP7025 |
| | | | | SHOKUBAI | |
| | | | | CO., LTD. | |

TABLE 5

| Ink (I-1) | Added amount [mass %] |
|---|---|
| Pigment dispersion liquid (D-1) | 40.0 |
| Surfactant (S-1) | 0.3 |
| Triethylene glycol mono-n-butylether | 4.0 |
| 2-pyrrolidone | 5.0 |
| Glycerin | 20.0 |
| Water | Remaining amount |
| Total | 100.0 |

### [Preparation of Filling Liquid]

Filling liquids (F-1) to (F-14) were prepared by the method described below. Frist, details of moisturizing agents (M-1) to (M-12) used for preparing the filling liquids (F-1) to (F-14) will be described below.

### [Moisturizing Agents (M-1) to (M-12)]

Compounds shown in the following Tables 6 and 7 were prepared by the method described below and used as the moisturizing agents (M-1) to (M-12). The viscosity of each of the moisturizing agents (M-1) to (M-12) was measured at 25° C. using a falling ball viscometer (“Lovis2000” manufactured by Anton Paar GmbH). Note that the moisturizing agents (M-2) to (M-5) and (M-8) to (M-11) were each a specific moisturizing agent. Further, the moisturizing agents (M-2) to (M-5) were each a compound in which a, b, and c satisfy the following relationship: a=b=c and a+b+c is a multiple of 3, of 6 or more and 18 or less in the general formula (1). Further, the moisturizing agents (M-8) to (M-12) were each a compound in which a, b, and c satisfy the relationship: a=c≠b in the general formula (1). Further, the moisturizing agents (M-8) to (M-12) were each a compound in which b is a+1 or a+2 in the general formula (1).

### [Preparation of Moisturizing Agents (M-2) to (M-6)]

Polyethylene glycol and glycerin were caused to react with each other at 200° C. to form an ether. As a result, compounds as the moisturizing agents (M-2) to (M-6) shown in Table 6 were synthesized. The obtained compounds were checked to have peaks of 99% or more of glycerin and polyethylene glycol by high performance liquid chromatography (HPLC). In detail, acetonitrile and water were added to the obtained compound and mixed, and the mixture was quantitatively analyzed by HPLC under the following conditions.
HPLC apparatus: “HITACHI D-7000” manufactured by Hitachi High-Tech Corporation
Flow rate: 1.0 mL/min
Detector: “Corona CAD Detector” manufactured by ESA Biosciences

### (Analysis Conditions for Glycerin)

Column: “TSK-GEL Amide-80” (5 μm, 4.6×250 mm) manufactured by TOSOH CORPORATION

Solution: 50 volume % acetonitrile/water (distilled water)

### (Analysis Conditions for Polyethylene Glycol)

Column: “InertsilC8-3” (5 μm, 4.6×150 mm) manufactured by GL Science
Solution: acetonitrile/water (distilled water)

After holding the volume ratio of acetonitrile in the solution at 45 volume % for 3 minutes, linear gradient was performed for 9 minutes until the volume ratio of acetonitrile reaches 98 volume % from 45 volume %. After that, the volume ratio of acetonitrile was held at 98 volume %.

### [Preparation of Moisturizing Agent (M-1)]

The compound as the moisturizing agent (M-1) shown in Table 6 was synthesized by the same method as that for the moisturizing agents (M-2) to (M-6) except that ethylene glycol was used instead of polyethylene glycol. The obtained compound was checked to have peaks of 99% or more of glycerin and ethylene glycol by the same method as that for the moisturizing agents (M-2) to (M-6).

### [Preparation of Moisturizing Agents (M-7) to (M-12)]

The compounds as the moisturizing agents (M-7) to (M-12) shown in Table 7 were synthesized by the same method as that for the moisturizing agents (M-2) to (M-6) except that the following points were changed. In the synthesis of the compounds as the moisturizing agents (M-7) to (M-12), first, polyethylene glycol and glycerin were caused to react with each other at 160° C. to complete the reaction of the two hydroxy groups at the α-positions bonded to the primary carbons of glycerin. This formed an intermediate. After that, this intermediate and polyethylene glycol were caused to react with each other at 220° C. to complete the reaction of the hydroxy group at the β-position bonded to the secondary carbon of glycerin. In this way, the compounds as the moisturizing agents (M-7) to (M-12) shown in Table 7 were synthesized. The obtained compounds were checked to have peaks of 99% or more of glycerin and polyethylene glycol by the same method as that for the moisturizing agents (M-1) to (M-6).

TABLE 6

| Moisturizing agent | M-1 | M-2 | M-3 | M-4 | M-5 | M-6 |
|---|---|---|---|---|---|---|
| a + b + c | 3 | 6 | 9 | 15 | 18 | 21 |
| a | 1 | 2 | 3 | 5 | 6 | 7 |
| b | 1 | 2 | 3 | 5 | 6 | 7 |
| c | 1 | 2 | 3 | 5 | 6 | 7 |
| Viscosity [mPa · s] | 480 | 410 | 350 | 310 | 280 | 250 |

TABLE 7

| Moisturizing agent | M-7 | M-8 | M-9 | M-10 | M-11 | M-12 |
|---|---|---|---|---|---|---|
| a + b + c | 4 | 8 | 11 | 17 | 19 | 23 |
| a | 1 | 2 | 3 | 5 | 6 | 7 |
| b | 2 | 4 | 5 | 7 | 7 | 9 |
| c | 1 | 2 | 3 | 5 | 6 | 7 |
| Viscosity [mPa · s] | 470 | 400 | 330 | 290 | 250 | 220 |

### [Preparation of Filling Liquid (F-1)]

30.0 parts by mass of the moisturizing agent (M-1), 0.2 parts by mass of the above-mentioned surfactant (S-1), and ion exchanged water were mixed to obtain a mixed solution. The amount of ion exchanged water added was the amount that the total amount of the mixed solution was 100.0 parts by mass. This mixed solution was used as the filling liquid (F-1).

### [Preparation of Filling Liquids (F-2) to (F-14)]

Filling liquids (F-2) to (F-14) were prepared by the same method as that for the preparation of the filling liquid (F-1) except that the type and amount of each component were changed as shown in Tables 8 to 10.

TABLE 8

| Filling liquid | | F-1 | F-2 | F-3 | F-4 | F-5 | F-6 | F-6 |
|---|---|---|---|---|---|---|---|---|
| Moisturizing | Type | M-1 | M-2 | M-3 | M-4 | M-5 | M-6 | M-6 |
| agent | a + b + c | 3 | 6 | 9 | 15 | 18 | 21 | 21 |
| | a | 1 | 2 | 3 | 5 | 6 | 7 | 7 |
| | b | 1 | 2 | 3 | 5 | 6 | 7 | 7 |
| | c | 1 | 2 | 3 | 5 | 6 | 7 | 7 |
| | Viscosity [mPa · s] | 480 | 410 | 350 | 310 | 280 | 250 | 250 |
| | Content ratio [mass %] | 30.0 | 30.0 | 30.0 | 30.0 | 30.0 | 30.0 | 30.0 |
| Surfactant | Content ratio [mass %] | 0.2 | 0.2 | 0.2 | 0.2 | 0.2 | 0.2 | 0.2 |
| (S-1) | | | | | | | | |
| Water | Content ratio [mass %] | Remaining | Remaining | Remaining | Remaining | Remaining | Remaining | Remaining |
| | | amount | amount | amount | amount | amount | amount | amount |

TABLE 9

| Filling liquid | | F-7 | F-8 | F-9 | F-10 | F-11 | F-12 |
|---|---|---|---|---|---|---|---|
| Moisturizing | Type | M-7 | M-8 | M-9 | M-10 | M-11 | M-12 |
| agent | a + b + c | 4 | 8 | 11 | 17 | 19 | 23 |
| | a | 1 | 2 | 3 | 5 | 6 | 7 |
| | b | 2 | 4 | 5 | 7 | 7 | 9 |
| | c | 1 | 2 | 3 | 5 | 6 | 7 |
| | Viscosity [mPa · s] | 470 | 400 | 330 | 290 | 250 | 220 |
| | Content ratio [mass %] | 30.0 | 30.0 | 30.0 | 30.0 | 30.0 | 30.0 |
| Surfactant | Content ratio [mass %] | 0.2 | 0.2 | 0.2 | 0.2 | 0.2 | 0.2 |
| (S-1) | | | | | | | |
| Water | Content ratio [mass %] | Remaining | Remaining | Remaining | Remaining | Remaining | Remaining |
| | | amount | amount | amount | amount | amount | amount |

TABLE 10

| Filling liquid | | F-13 | F-14 |
|---|---|---|---|
| Moisturizing | Type | M-2 | M-2 |
| agent | a + b + c | 6 | 6 |
| | a | 2 | 2 |
| | b | 2 | 2 |
| | c | 2 | 2 |
| | Viscosity [mPa · s] | 410 | 410 |
| | Content ratio [mass %] | 15.0 | 45.0 |
| Surfactant (S-1) | Content ratio [mass %] | 0.2 | 0.2 |
| Water | Content ratio [mass %] | Remaining | Remaining |
| | | amount | amount |

### [Preparation of Ink Set]

The ink (I-1) and one of the filling liquids (F-1) to (F-14) were combined as shown in the following Tables 11 to 13. In this way ink sets according to Examples 1 to 10 and Comparative Examples 1 to 4 were prepared.

### [Evaluation 1]

The performance to suppress ink aggregation (performance to suppress aggregation of the pigment component in the ink) in an open system (with evaporation) and a closed system (without evaporation), purgeability of the filling liquid (whether or not the filling liquid can be purged after being left to stand), and the introduction property of the filling liquid (property of the filling liquid that is easily introduced into the ink flow path in the recording head) of the ink sets according to Examples 1 to 10 and Comparative Examples 1 to 4 were evaluated by the following method. The evaluation results are shown in the following Tables 11 to 13.

### (Performance to Suppress Aggregation (Open System))

1.0 parts by mass of the ink (in Study 1, the ink (I-1)) included in the ink set to be evaluated and 50.0 parts by mass of the filling liquid (in Study 1, one of the filling liquids (F-1) to (F-14)) were mixed in a beaker. Next, the beaker containing the mixed solution was preserved in a constant temperature bath at 40° C. for one month without sealing the beaker (preservation treatment). For the mixed solution after treatment, the presence or absence of aggregation having a particle diameter of 3 μm or more was analyzed using a particle shape image analyzer (“FPIA (registered trademark)-3000” manufactured by Malvern Panalytical Ltd.).

Note that in the case where the recording head is filled with the filling liquid after inspecting the recording head, the residual ink and the filling liquid are mixed inside the recording head. The mixing ratio of the residual ink and the filling liquid (amount of ink/amount of filling liquid) differs depending on the part of the recording head, but is expected to be approximately 1/50 at maximum. In this regard, the mixing ratio of the ink and the filling liquid was set to 1.0 part by mass of the ink: 50.0 parts by mass of the filling liquid. Further, there is a possibility that aggregates having a particle diameter of 3 μm or more generated inside the recording head clog the filter disposed inside the recording head, causing an ejection failure of the ink. In this regard, whether or not aggregates having a particle diameter of 3 μm or more are generated after preservation was used as criteria for determining whether or not aggregation of the ink could be suppressed.

### (Performance to Suppress Aggregation (Closed System))

“Performance to suppress aggregation (closed system)” was evaluated in the same manner as that for the above-mentioned “Performance to suppress aggregation (open system)” except that the following points were changed. In the evaluation of “Performance to suppress aggregation (closed system)”, the beaker was sealed with parafilm during preservation to prevent the content from evaporating. The evaluation conditions for the “Performance to suppress aggregation (closed system)” are milder than those for the “Performance to suppress aggregation (open system)”, because the pigment components are not concentrated due to evaporation of the solvent.

### (Criteria for Determining Performance to Suppress Aggregation)

A (Pass): In both the open system and the closed system, aggregates having a particle diameter of 3 μm or more were not generated after preservation.
B (Fail): In at least one of the open system or the closed system, aggregates having a particle diameter of 3 μm or more were generated after preservation.

### (Purgeability)

When purging the filling liquid from the recording head left to stand in a high-temperature environment, the viscosity of the filling liquid around the nozzle increases due to evaporation of the water-soluble organic solvent and water of the filling liquid in the recording head left to stand. When the viscosity of the filling liquid increase, the pressure (purge pressure) of the recording head when purging the filling liquid increases to destroy the recording head. In accordance with the present inventors' study, when the viscosity of the moisturizing agent at 25° C. is 450 mPa·s or less, the purge pressure does not increase, the filling liquid can be purged without any problem, and there is no risk of destroying the recording head. In this regard, whether or not the viscosity of the moisturizing agent at 25° C. is 450 mPa·s or less was used as criteria for determining the purgeability of the filling liquid (whether or not the filling liquid can be purged after being left to stand).

### (Criteria for Determining Purgeability)

A (Pass): the viscosity of the moisturizing agent at 25° C. is 450 mPa·s or less
B (Fail): the viscosity of the moisturizing agent at 25° C. exceeds 450 mPa·s

### (Introduction Property)

First, an unused recording head (“KJ4B-QA” manufactured by KYOCERA Corporation, total number of nozzles: 2656) was filled with 100 cc of the ink (in Study 1, the ink (I-1)) included in the ink set to be evaluated and was caused to eject the ink. Subsequently, this recording head was washed with pure water and then dried sufficiently. Next, this recording head was filled with 300 cc of the filling liquid (in Study 1, one of the filling liquids (F-1) to (F-14)) included in the ink set to be evaluated and was caused to eject the ink. This operation was performed a total of 10 times. After that, the recording head was filled with the filling liquid again. After that, a nozzle check pattern was printed on a glass plate using the recording head filled with the filling liquid. In this way, a nozzle check pattern was formed on a glass plate using the filling liquid. Next, by reading the above-mentioned glass plate with a scanner, the number of ejection nozzles that were able to eject the filling liquid (number of ejection nozzles) was counted. The ratio [%] (introduction ratio) of the number of ejection nozzles to the total number of nozzles of the recording head (2656) was obtained by the following formula. The introduction property of the filling liquid was judged in accordance with the following criteria.

$$Introduction ratio = 100 \times number of ejection nozzles / total number of nozzles$$

### (Criteria for Determining Introduction Property)

A (Pass): the introduction ratio is 90% or more
B (Fail): the introduction ratio is less than 90%

### [Dynamic Surface Tension]

Further, the dynamic surface tension of the ink according to each of Examples and Comparative Examples at the surface age of 10 ms and the dynamic surface tension of the filling liquid according to each of Examples and Comparative Examples at the surface age of 10 ms were measured at 25° C. by a maximum bubble pressure method using a bubble pressure dynamic surface tensiometer (“BP100” manufactured by KRUSS GmbH, capillary diameter of 0.4 mm). The measurement results are shown in the following Tables 11 to 13.

TABLE 11

| | | Comparative | Example | Example | Example | Example | Comparative |
|---|---|---|---|---|---|---|---|
| | | Example 1 | 1 | 2 | 3 | 4 | Example 2 |
| Ink | Type of ink | I-1 | I-1 | I-1 | I-1 | I-1 | I-1 |
| | Type of surfactant | S-1 | S-1 | S-1 | S-1 | S-1 | S-1 |
| | Raio of surfactant | 0.3 | 0.3 | 0.3 | 0.3 | 0.3 | 0.3 |
| Filling | Type of filling liquid | F-1 | F-2 | F-3 | F-4 | F-5 | F-6 |
| liquid | Type of moisturizing agent | M-1 | M-2 | M-3 | M-4 | M-5 | M-6 |
| | Ratio of moisturizing agent | 30.0 | 30.0 | 30.0 | 30.0 | 30.0 | 30.0 |
| | Viscosity of moisturizing agent | 480 | 410 | 350 | 310 | 280 | 250 |
| | [mPa · s] | | | | | | |
| | Type of surfactant | S-1 | S-1 | S-1 | S-1 | S-1 | S-1 |
| | Ratio of surfactant | 0.2 | 0.2 | 0.2 | 0.2 | 0.2 | 0.2 |

| Performance to suppress aggregation | | A | A | A | A | A | B |
|---|---|---|---|---|---|---|---|
| Purgeability | | B | A | A | A | A | A |
| Introduction property | | A | A | A | A | A | A |
| Introduction ratio [%] | | 92 | 95 | 94 | 92 | 96 | 95 |
| Dynamic surface | Ink | 33 | 34 | 33 | 34 | 33 | 33 |
| tension [mN/m] | Filling liquid | 33 | 34 | 33 | 34 | 33 | 33 |

TABLE 12

| | | Comparative | Example | Example | Example | Example | Comparative |
|---|---|---|---|---|---|---|---|
| | | Example 3 | 5 | 6 | 7 | 8 | Example 4 |
| Ink | Type of ink | I-1 | I-1 | I-1 | I-1 | I-1 | I-1 |
| | Type of surfactant | S-1 | S-1 | S-1 | S-1 | S-1 | S-1 |
| | Raio of surfactant | 0.3 | 0.3 | 0.3 | 0.3 | 0.3 | 0.3 |
| Filling | Type of filling liquid | F-7 | F-8 | F-9 | F-10 | F-11 | F-12 |
| liquid | Type of moisturizing agent | M-7 | M-8 | M-9 | M-10 | M-11 | M-12 |
| | Ratio of moisturizing agent | 30.0 | 30.0 | 30.0 | 30.0 | 30.0 | 30.0 |
| | Viscosity of moisturizing agent | 470 | 400 | 330 | 290 | 250 | 220 |
| | [mPa · s] | | | | | | |
| | Type of surfactant | S-1 | S-1 | S-1 | S-1 | S-1 | S-1 |
| | Ratio of surfactant | 0.2 | 0.2 | 0.2 | 0.2 | 0.2 | 0.2 |

| Performance to suppress aggregation | | A | A | A | A | A | B |
|---|---|---|---|---|---|---|---|
| Purgeability | | B | A | A | A | A | A |
| Introduction property | | A | A | A | A | A | A |
| Introduction ratio [%] | | 91 | 92 | 93 | 94 | 93 | 99 |
| Dynamic surface | Ink | 33 | 34 | 33 | 34 | 33 | 33 |
| tension [mN/m] | Filling liquid | 33 | 34 | 33 | 34 | 33 | 33 |

TABLE 13

| | | Example 9 | Example 10 |
|---|---|---|---|
| Ink | Type of ink | I-1 | I-1 |
| | Type of surfactant | S-1 | S-1 |
| | Raio of surfactant | 0.3 | 0.3 |
| Filling | Type of filling liquid | F-13 | F-14 |
| liquid | Type of moisturizing agent | M-2 | M-2 |
| | Ratio of moisturizing agent | 15.0 | 45.0 |
| | Viscosity of moisturizing agent | 410 | 410 |
| | [mPa · s] | | |
| | Performance to | A | A |
| | suppress aggregation | | |
| | Type of surfactant | S-1 | S-1 |
| | Ratio of surfactant | 0.2 | 0.2 |
| Purgeability | | A | A |
| Introduction property | | A | A |
| Introduction ratio [%] | | 91 | 93 |
| Dynamic | Ink | 33 | 33 |
| surface | Filling liquid | 32 | 34 |
| tension | | | |
| [mN/m] | | | |

In Tables 11 to 13, the “type of surfactant” indicates the type of surfactant included in the ink (first surfactant) or surfactant included in the filling liquid (second surfactant). The “ratio of surfactant” indicates the content ratio [mass %] of the surfactant included in the ink (first surfactant) or the surfactant included in the filling liquid (second surfactant). The “type of moisturizing agent” indicates the type of moisturizing agent included in the filling liquid. The “ratio of moisturizing agent” indicates the content ratio [mass %] of the moisturizing agent in the filling liquid.

As shown in Tables 3 to 13, the ink according to each Example included a pigment, a first surfactant, and an aqueous medium, and the filling liquid included a specific moisturizing agent, a second surfactant, and water. Further, the specific moisturizing agent was the compound represented by the general formula (1), and the first surfactant and the second surfactant were each the compound represented by the general formula (2).

As shown in Tables 3 to 13, when a+b+c in the general formula (1) of the moisturizing agent is less than 5, the purgeability of the filling liquid is Fail. Meanwhile, when a+b+c in the general formula (1) of the moisturizing agent exceeds 20, sufficient performance to suppress ink aggregation cannot be achieved. Therefore, it was found that a+b+c in the general formula (1) of the moisturizing agent was favorably 5 or more and 20 or less.

Further, as shown in Tables 3 to 13, in the case where the content ratio of the specific moisturizing agent in the filling liquid was 10.0 mass % or more and 50.0 mass % or less, the evaluation results were favorable. From this fact, it was found that in the case where the content ratio of the specific moisturizing agent in the filling liquid was within the above-mentioned range, it was possible to reliably obtain an ink set that allows a filling liquid to be easily introduced into an ink flow path in a recording head and is capable of effectively suppressing aggregation of a pigment component in an ink in the recording head and stably purging the filling liquid.

### [Study 2: Type and Amount of Surfactant]

Next, the type and amount of surfactant included in each of the filling liquid and the ink were studied.

### [Preparation of Surfactants (S-2) to (S-7)]

As surfactants, the above-mentioned surfactant (S-1) and surfactants (S-2) to (S-7) shown in the following Table 14 were prepared. In the product name in the following Table 14, “(R)” represents registered trademark. Of the surfactants (S-1) to (S-7), the surfactants (S-1) and (S-3) to (S-5) were each the compound represented by the general formula (2). The surfactant (S-2) was a surfactant in which y=0.0 in the general formula (2), of the surfactant. The surfactant (S-6) was a surfactant in which y=1.0 in the general formula (2) of the surfactant. In the following Table 14, m+n, x, and y respectively indicate numerical values of m+n, x, and y in the general formula (2) of the surfactant.

TABLE 14

| Surfactant | m + n | x | y | Manufacturer | Product name |
|---|---|---|---|---|---|
| S-2 | 10.0 | 12.0 | 0.0 | In-house preparation | |
| S-3 | 9.0 | 15.0 | 8.0 | | |
| S-4 | 10.0 | 13.0 | 4.0 | | |
| S-5 | 11.0 | 13.0 | 4.0 | | |
| S-6 | 10.0 | 13.0 | 1.0 | | |
| S-7 | Acetylene glycol | | | Nissin Chemical | SURFYNOL |
| | surfactant | | | co., ltd. | (R)440 |

### [Preparation of Surfactant]

Compounds shown in Table 14 were prepared by the method described below and used as the surfactants (S-2) to (S-6).

### [Preparation of Surfactant (S-2)]

197 g (equivalent to 1 mole) of branched alcohol corresponding to m+n=10.0 in the general formula (2) and 3 g of KOH were mixed to obtain a mixed solution. This mixed solution was dehydrated for 30 minutes while causing the mixed solution to react at 110° C. and 1.3 kPa using an autoclave including a stirring device, a temperature control device, and an automatic introduction device. In this way, part of water in the mixed solution was removed. After dehydrating the mixed solution, nitrogen substitution was performed and the autoclave was heated to 155° C. After that, 314 g (equivalent to 1 mole and corresponding to x in the general formula (2)) of ethyleneoxide was added to the mixed solution in the autoclave by the automatic introduction device. After adding ethyleneoxide, the autoclave was maintained at 155° C. and the reaction was performed for 30 minutes. By performing gas chromatography analysis of the reaction solution, the fact that no components of each raw material remained was checked, and it was determined that the compound obtained by this reaction was a target substance having the values of m+n, x, and y shown in Table 14. The compound obtained by this reaction was used as the surfactant (S-2).

### [Preparation of Surfactants (S-3) to (S-6)]

Compounds as the surfactants (S-3) to (S-6) shown in Table 14 were synthesized by the same method as that for the preparation of the surfactant (S-2) except that the type and amount of raw material used and the reaction time were changed such that the numerical values of m+n, x, and y in the general formula (2) were the corresponding values shown in Table 14. Branched alcohol preferentially reacts with not a propyleneoxide moiety but an ethyleneoxide moiety. For this reason, by changing the type and amount of raw material used and the reaction time, the surfactants (S-3) to (S-6) shown in Table 14 can be prepared.

### [Preparation of Inks (I-2) to (I-10)]

Inks (I-2) to (I-10) were prepared by the same method as that for the preparation of the ink (I-1) except that the type and amount of each raw material added were changed as shown in the following Table 15 or 16. Note that “TGBE” shown in Tables 15 and 16 indicates triethylene glycol mono-n-butylether.

TABLE 15

| Ink | | I-2 | I-3 | I-4 | I-5 | I-6 |
|---|---|---|---|---|---|---|
| Added | Pigment dispersion | 40.0 | 40.0 | 40.0 | 40.0 | 40.0 |
| amount | liquid (D-1) | | | | | |
| [mass %] | Surfactant (S-1) | — | — | — | — | — |
| | Surfactant (S-2) | 0.3 | — | — | — | — |
| | Surfactant (S-3) | — | — | 0.3 | — | — |
| | Surfactant (S-4) | — | — | — | 0.3 | — |
| | Surfactant (S-5) | — | — | — | — | 0.3 |
| | Surfactant (S-6) | — | — | — | — | — |
| | Surfactant (S-7) | — | — | — | — | — |
| | TGBE | 4.0 | 4.0 | 4.0 | 4.0 | 4.0 |
| | 2-pyrrolidone | 5.0 | 5.0 | 5.0 | 5.0 | 5.0 |
| | Glycerin | 20.0 | 20.0 | 20.0 | 20.0 | 20.0 |
| | Water | Remaining | Remaining | Remaining | Remaining | Remaining |
| | | amount | amount | amount | amount | amount |
| | Total | 100.0 | 100.0 | 100.0 | 100.0 | 100.0 |

TABLE 16

| Ink | | I-7 | I-8 | I-9 | I-10 |
|---|---|---|---|---|---|
| Added | Pigment | 40.0 | 40.0 | 40.0 | 40.0 |
| amount | dispersion | | | | |
| [mass | liquid (D-1) | — | — | — | — |
| %] | Surfactant (S-1) | — | — | 0.2 | 0.9 |
| | Surfactant (S-2) | — | — | — | — |
| | Surfactant (S-3) | — | — | — | — |
| | Surfactant (S-4) | — | — | — | — |
| | Surfactant (S-5) | — | — | — | — |
| | Surfactant (S-6) | 0.3 | — | — | — |
| | Surfactant (S-7) | — | 0.3 | — | — |
| | TGBE | 4.0 | 4.0 | 4.0 | 4.0 |
| | 2-pyrrolidone | 5.0 | 5.0 | 5.0 | 5.0 |
| | Glycerin | 20.0 | 20.0 | 20.0 | 20.0 |
| | Water | Remaining | Remaining | Remaining | Remaining |
| | | amount | amount | amount | amount |
| | Total | 100.0 | 100.0 | 100.0 | 100.0 |

### [Preparation of Filling Liquids (F-15) to (F-23)]

Filling liquids (F-15) to (F-23) were prepared by the same method as that for the preparation of the filling liquid (F-1) except that the type and amount of each component were changed as shown in Table 17 or Table 18.

TABLE 17

| Filling liquid | | F-15 | F-16 | F-17 | F-18 | F-19 | F-20 |
|---|---|---|---|---|---|---|---|
| Content | Moisturizing | 35.0 | 35.0 | 35.0 | 35.0 | 35.0 | 35.0 |
| ratio | agent (M-3) | | | | | | |
| [mass %] | Surfactant (S-1) | 0.2 | — | — | — | — | — |
| | Surfactant (S-2) | — | 0.2 | — | — | — | — |
| | Surfactant (S-3) | — | — | — | 0.2 | — | — |
| | Surfactant (S-4) | — | — | — | — | 0.2 | — |
| | Surfactant (S-5) | — | — | — | — | — | 0.2 |
| | Surfactant (S-6) | — | — | — | — | — | — |
| | Surfactant (S-7) | — | — | — | — | — | — |
| | Water | Remaining | Remaining | Remaining | Remaining | Remaining | Remaining |
| | | amount | amount | amount | amount | amount | amount |

TABLE 18

| Filling liquid | | F-21 | F-22 | F-23 |
|---|---|---|---|---|
| Content | Moisturizing agent (M-3) | 35.0 | 35.0 | 35.0 |
| ratio | Surfactant (S-1) | — | — | 0.9 |
| [mass %] | Surfactant (S-2) | — | — | — |
| | Surfactant (S-3) | — | — | — |
| | Surfactant (S-4) | — | — | — |
| | Surfactant (S-5) | — | — | — |
| | Surfactant (S-6) | 0.2 | — | — |
| | Surfactant (S-7) | — | 0.2 | — |
| | Water | Remaining | Remaining | Remaining |
| | | amount | amount | amount |

### [Preparation of Ink Set]

As shown in the following Tables 19 to 21, one of the inks (I-1) to (I-10) and one of the filling liquids (F-2) and (F-15) to (F-23) were combined. In this way, the ink sets according to Examples 11 to 18 and Comparative Examples 5 to 10 were prepared.

### [Evaluation 2]

The performance to suppress ink aggregation, the purgeability of the filling liquid, and the introduction property of the filling liquid of the ink set according to Examples 11 to 18 and Comparative Examples 5 to 10 were evaluated by the same method as the method described in [Evaluation 1]. However, in [evaluation 2], one of the inks (I-1) to (I-10) was used as the ink included in the ink set to be evaluated, as described above. Further, one of the filling liquids (F-2) and (F-15) to (F-23) was used as the filling liquid included in the ink set to be evaluated. The evaluation results are shown in the following Tables 19 to 21. Further, the dynamic surface tension of the ink according to each of Examples and Comparative Examples at the surface age of 10 ms and the dynamic surface tension of the filling liquid according to each of Examples and Comparative Examples at the surface age of 10 ms were measured by the method described in [Study 1: type and amount of moisturizing agent in filling liquid]. The measurement results are shown in the following Tables 19 to 21.

TABLE 19

| | | Example | Comparative | Comparative | Comparative | Example |
|---|---|---|---|---|---|---|
| | | 11 | Example 5 | Example 6 | Example 7 | 12 |
| Ink | Type of ink | I-1 | I-2 | I-1 | I-3 | I-4 |
| | Type of surfactant | S-1 | S-2 | S-1 | — | S-3 |
| | Raio of surfactant | 0.3 | 0.3 | 0.3 | — | 0.3 |
| Filling | Type of filling liquid | F-15 | F-15 | F-16 | F-17 | F-18 |
| liquid | Type of moisturizing agent | M-3 | M-3 | M-3 | M-3 | M-3 |
| | Ratio of moisturizing agent | 35.0 | 35.0 | 35.0 | 35.0 | 35.0 |
| | Type of surfactant | S-1 | S-1 | S-2 | — | S-3 |
| | Ratio of surfactant | 0.2 | 0.2 | 0.2 | — | 0.2 |

| Performance to suppress aggregation | | A | A | A | A | A |
|---|---|---|---|---|---|---|
| Purgeability | | A | A | A | A | A |
| Introduction property | | A | B | B | B | A |
| Introduction ratio [%] | | 93 | 73 | 79 | 81 | 95 |
| Dynamic surface | Ink | 34 | 37 | 33 | 45 | 31 |
| tension [mN/m] | Filling liquid | 34 | 34 | 37 | 53 | 30 |

TABLE 20

| | | Example | Example | Comparative | Example | Comparative | Comparative |
|---|---|---|---|---|---|---|---|
| | | 13 | 14 | Example 8 | 15 | Example 9 | Example 10 |
| Ink | Type of ink | I-5 | I-6 | I-7 | I-4 | I-8 | I-1 |
| | Type of surfactant | S-4 | S-5 | S-6 | S-3 | S-7 | S-1 |
| | Raio of surfactant | 0.3 | 0.3 | 0.3 | 0.3 | 0.3 | 0.3 |
| Filling | Type of filling liquid | F-19 | F-20 | F-21 | F-15 | F-15 | F-22 |
| liquid | Type of moisturizing agent | M-2 | M-2 | M-2 | M-2 | M-2 | M-2 |
| | Ratio of moisturizing agent | 35.0 | 35.0 | 35.0 | 35.0 | 35.0 | 35.0 |
| | Type of surfactant | S-4 | S-5 | S-6 | S-1 | S-1 | S-7 |
| | Ratio of surfactant | 0.2 | 0.2 | 0.2 | 0.2 | 0.2 | 0.2 |

| Performance to suppress aggregation | | A | A | A | A | A | A |
|---|---|---|---|---|---|---|---|
| Purgeability | | A | A | A | A | A | A |
| Introduction property | | A | A | B | A | B | B |
| Introduction ratio [%] | | 92 | 91 | 85 | 92 | 83 | 85 |
| Dynamic surface | Ink | 33 | 33 | 36 | 33 | 37 | 36 |
| tension [mN/m] | Filling liquid | 34 | 33 | 36 | 33 | 37 | 36 |

TABLE 21

| | | Example 16 | Example 17 | Example 18 |
|---|---|---|---|---|
| Ink | Type of ink | I-9 | I-10 | I-1 |
| | Type of surfactant | S-1 | S-1 | S-1 |
| | Raio of surfactant | 0.2 | 0.9 | 0.3 |
| Filling | Type of filling liquid | F-2 | F-2 | F-23 |
| liquid | Type of moisturizing | M-2 | M-2 | M-2 |
| | agent | | | |
| | Ratio of moisturizing | 30.0 | 30.0 | 35.0 |
| | agent | | | |
| | Type of surfactant | S-1 | S-1 | S-1 |
| | Ratio of surfactant | 0.2 | 0.2 | 0.9 |
| Performance to suppress | | A | A | A |
| aggregation | | | | |
| Purgeability | | A | A | A |
| Introduction property | | A | A | A |
| Introduction ratio [%] | | 95 | 96 | 92 |
| Dynamic | Ink | 34 | 31 | 34 |
| surface | Filling | 34 | 34 | 30 |
| tension | liquid | | | |
| [mN/m] | | | | |

In Tables 19 to 21, the “type of surfactant” indicates the type of surfactant included in the ink (first surfactant) or surfactant included in the filling liquid (second surfactant). The “ratio of surfactant” indicates the content ratio [mass %] of the surfactant included in the ink (first surfactant) or the surfactant included in the filling liquid (second surfactant). The “type of moisturizing agent” indicates the type of moisturizing agent included in the filling liquid. The “ratio of moisturizing agent” indicates the content ratio of [mass %] of the moisturizing agent in the filling liquid.

As shown in Tables 14 to 21, the ink according to each Example included a pigment, a first surfactant, and an aqueous medium, and the filling liquid included a specific moisturizing agent, a second surfactant, and water. Further, the specific moisturizing agent was the compound represented by the general formula (1) and the first surfactant and the second surfactant were each the compound represented by the general formula (2).

As shown in Tables 14 to 21, when the first surfactant and the second surfactant are each the compound represented by the general formula (2), the filling liquid is easily introduced into the ink flow path in the recording head.

However, as shown in Comparative Example 7, when the ink and the filling liquid do not include surfactants, the dynamic surface tension of each of the ink and the filling liquid is high and the filling liquid is difficult to introduce in the ink flow path in the recording head. In the case where the ink and the filling liquid do not include surfactants, the dynamic surface tension of each of the ink and the filling liquid at 25° C. and the surface age of 10 ms is 35 mN/m or more.

Further, as shown in Comparative Example 5, when a compound in which y=0.0 in the general formula (2), which does not include a propylene oxide group, is used as the surfactant of the ink, the dynamic surface tension of the ink increases, and thus, the filling liquid is difficult to introduce into the ink flow path in the recording head. In this case, the dynamic surface tension of the ink at 25° C. and the surface age of 10 ms is 35 mN/m or more.

Further, as shown in Comparative Example 6, when a compound in which y=0.0 in the general formula (2), which does not include a propylene oxide group, is used as the surfactant of the filling liquid, the dynamic surface tension of the filling liquid increases and the filling liquid is difficult to introduce into the ink flow path in the recording head. In this case, the dynamic surface tension of the filling liquid at 25 and the surface age of 10 ms is 35 mN/m or more.

Further, as shown in Comparative Example 8, also in the case where a compound in which y=1.0 in the general formula (2) is used as the surfactant of the ink and the surfactant of the filling liquid, the dynamic surface tension of each of the ink and the filling liquid increases and the filling liquid is difficult to introduce into the ink flow path in the recording head. In the case where a compound in which y=1.0 in the general formula (2) is used as each of the first surfactant and the second surfactant, the dynamic surface tension of each of the ink and the filling liquid at 25° C. and the surface age of 10 ms is 35 mN/m or more.

Further, as shown in Tables 14 to 21, it was found that although the first surfactant and the second surfactant were favorably the same compound, they might be different compounds and only needed to each be independently the compound represented by the general formula (2).

Further, as shown in Tables 14 to 21, in the case where the content ratio of the first surfactant in the ink was 0.1 mass % or more and 2.5 mass % or less, the evaluation results were favorable. From this fact, it was found that in the case where the content ratio of the first surfactant in the ink was within the above-mentioned range, it was possible to reliably obtain an ink set that allows a filling liquid to be easily introduced into an ink flow path in a recording head and is capable of effectively suppressing aggregation of a pigment component in an ink in the recording head and stably purging the filling liquid.

Further, as shown in Tables 14 to 21, in the case where the content ratio of the second surfactant in the filling liquid was 0.1 mass % or more and 2.5 mass % or less, the evaluation results were favorable. From this fact, it was found that in the case where the content ratio of the second surfactant in the filling liquid was within the above-mentioned range, it was possible to reliably obtain an ink set that allows a filling liquid to be easily introduced into an ink flow path in a recording head and is capable of effectively suppressing aggregation of a pigment component in an ink in the recording head and stably purging the filling liquid.

It should be understood by those skilled in the art that various modifications, combinations, sub-combinations and alterations may occur depending on design requirements and other factors insofar as they are within the scope of the appended claims or the equivalents thereof.

What is claimed is:

1. An ink set, comprising:
an inkjet ink that includes a pigment, a first surfactant, and an aqueous medium; and
a recording head filling liquid that includes a specific moisturizing agent, a second surfactant, and water,
the specific moisturizing agent being a compound represented by the following general formula (1), the first surfactant and the second surfactant being each independently a compound represented by the following general formula (2), 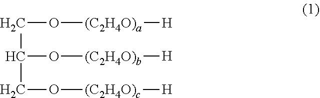
wherein, in the general formula (1), a, b, and c each independently represent an integer of 1 or more, and a+b+c is 5 or more and 20 or less, 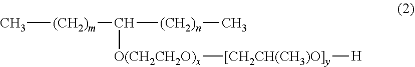
wherein, in the general formula (2), m and n each independently represent a number of 0.0 or more and 12.0 or less, m+n is 8.0 or more and 12.0 or less, x represents a number of 1.0 or more and 20.0 or less, and y represents a number of 2.0 or more and 10.0 or less.

2. The ink set according to claim 1, wherein
viscosity of the specific moisturizing agent at 25° C. is 230 mPa·s or more and 450 mPa·s or less.

3. The ink set according to claim 1, wherein
a content ratio of the specific moisturizing agent in the recording head filling liquid is 10.0 mass % or more and 50.0 mass % or less.

4. The ink set according to claim 1, wherein
a content ratio of the first surfactant in the inkjet ink is 0.1 mass % or more and 2.5 mass % or less.

5. The ink set according to claim 1, wherein
a content ratio of the second surfactant in the recording head filling liquid is 0.1 mass % or more and 2.5 mass % or less.

6. The ink set according to claim 1, wherein
the first surfactant and the second surfactant are the same compound.

7. The ink set according to claim 1, wherein
in the general formula (1), a, b, and c satisfy the following relationship: a=b=c, and a+b+c is a multiple of 3, of 6 or more and 18 or less.

8. The ink set according to claim 1, wherein
in the general formula (1), a, b, and c satisfy the following relationship:
a=c≠b.

9. The ink set according to claim 8, wherein
in the general formula (1), b is a+1 or a+2.

10. The ink set according to claim 1, wherein
in the general formula (2), x represents a number of 6.0 or more and 8.0 or less, and y represents a number of 2.0 or more and 3.0 or less.

11. The ink set according to claim 1, wherein
in the general formula (1), a+b+c is 6 or more and 10 or less, and
in the general formula (2), x represents a number of 6.0 or more and 8.0 or less and y represents a number of 2.0 or more and 3.0 or less.

12. A method of inspecting a recording head using the ink set according to claim 1, comprising:
an inspection step of inspecting ejection performance of the recording head; and
a filling step of filling the recording head after the inspection step with the recording head filling liquid,
the ejection performance of the recording head being inspected by ejecting the inkjet ink by the recording head in the inspection step.

13. The method of inspecting a recording head according to claim 12, wherein
the recording head is a line-type recording head.
